(19) United States
(12) Patent Application Publication
(10) Pub. No.: US 2015/0104965 A1
(43) Pub. Date: Apr. 16, 2015

(54) TERMINAL LOCKING STRUCTURE FOR ELECTRICAL CONNECTOR

(71) Applicant: SMK Corporation, Tokyo (JP)

(72) Inventor: Tetsuya Takagi, Toyama-shi (JP)

(21) Appl. No.: 14/510,690

(22) Filed: Oct. 9, 2014

(30) Foreign Application Priority Data
Oct. 10, 2013 (JP) 2013-212396

(51) Int. Cl. H01R 13/629; H01R 13/642; H01R 13/52

(52) U.S. Cl. CPC H01R 13/629; H01R 13/5202; H01R 13/642
USPC 439/310

(57) ABSTRACT

Provided is a terminal locking structure for an electrical connector excellent in assembly even when the locking position of a lance of a terminal is restricted, wherein, in the terminal locking structure that locks a terminal into a housing of the electrical connector with a lance, the terminal includes the lance and a stabilizer on an outer circumference of a cylindrical part thereof, the housing includes: an insertion part into which the terminal is inserted; a lance locking part provided only at a predetermined position along an inner circumference of the insertion part; and a guide part for the stabilizer, the guide part being inserted along the insertion part.

### CROSS-REFERENCE TO RELATED APPLICATION

This application claims priority of Japanese Patent Application No. 2013-212396 filed Oct. 10, 2013, which is incorporated herein by reference in its entirety.

### BACKGROUND

1. Technical Field

The present invention relates to a terminal locking structure for an electrical connector.

2. Related Art

In the field of electrical connectors for cable connections using electrical socket and plug connectors, such as electrical cable connectors for solar panels, a cylindrical terminal 20 provided with a lance 22a on the outer circumference thereof is inserted into an insertion part 112 of a housing 111 and the lance 22a are locked in a locking part 114 as shown in FIG. 7, for example.

In this case, the locking part 114 is formed in a stepped shape over the entire inner circumference thereof, and thus the direction in which the terminal is inserted is not limited but the lances can be properly locked by inserting the terminal at any angle around the circumference of 360 degrees.

If, however, a region 15 without any locking part is present because the locking part 14 for lances cannot be provided owing to restriction in fitting with a counterpart connector, strength setting, or the like as shown in FIG. 1, for example, there is a problem that the terminal cannot be locked and held in the housing if lances are inserted toward the region 15 without any locking part.

Furthermore, if the terminal is turned after locking the terminal in the housing, the lances may come off and detach from the locking part.

JP 2005-158330 A discloses, in a method for attaching a terminal into a housing, a technique of providing a positioning protrusion that comes in contact with the housing when the terminal is incorrectly inserted, so as to prevent incorrect insertion. This technique, however, does not guide the terminal so that the terminal is inserted in a proper direction.

### SUMMARY

An objective of the present invention is to provide a terminal locking structure for an electrical connector excellent in assembly even when the locking position of lances is restricted.

A terminal locking structure for an electrical connector according to the present invention is a terminal locking structure for an electrical connector that locks a terminal into a housing of the electrical connector with a lance, wherein the terminal includes the lance and a stabilizer on an outer circumference of a cylindrical part thereof, the housing includes: an insertion part into which the terminal is inserted; a lance locking part provided only at a predetermined position along an inner circumference of the insertion part; and a guide part for the stabilizer, the guide part being inserted along the insertion part, and when the terminal is inserted into the insertion part of the housing, the stabilizer turns along the circumference along the guide part, which rotates the terminal to guide the lance to the lance locking part provided at the predetermined position of the housing.

In the present invention, an electrical connector is a connector that connects a cable to a terminal, inserts the terminal into an insulating housing and locking the terminal with a lance, and is applied to both socket connectors and plug connectors.

Since insertion of the terminal into the insertion part of the housing in this manner brings the stabilizer in sliding contact with and along the guide part so that the lance comes to the predetermined position, the terminal can be inserted at any angle around the circumference for attaching the terminal into the housing even when the locking position of the lance is restricted.

In the present invention, three or more stabilizers may be provided along the circumference of the cylindrical part, the guide part may have a tapered shape that becomes wider from a terminal insertion end toward a terminal insertion rear portion thereof, the terminal may be rotated while being inserted so that the guide part is positioned between two adjacent stabilizers of the stabilizers and the lance is guided to the predetermined position.

As a result, the terminal is positioned so that the guide part is inserted between the adjacent stabilizers, which can restrict rotation of the terminal and the lance is prevented from coming off the locking part after the terminal is inserted and attached into the housing owing to rotation of the terminal.

### EFFECTS OF THE INVENTION

The terminal locking structure according to the present invention allows the stabilizer of the terminal to be turned and guided to the predetermined position by the guide part of the housing even when the locking position of the lance is restricted, which eliminates restriction of the angle around the circumference at which the terminal is inserted into the housing, and the terminal locking structure is therefore excellent in assembly.

### BRIEF DESCRIPTION OF DRAWINGS

FIG. 1 is a perspective view showing a state in which a terminal is inserted and attached into a housing of an electrical connector from the rear of the housing;

FIG. 2 is a cross-sectional perspective view taken along line A-A;

FIG. 3A is a sectional view taken along line A-A, and FIG. 3B shows, by a dotted line, relative positions of a stabilizer and a guide part in a state in which the terminal is attached;

FIG. 4A is a sectional view taken along line B-B, and FIG. 4B shows a state after the terminal is attached;

FIGS. 5A to 5C are explanatory views for explaining that insertion of the terminal into an insertion part of the housing brings the stabilizer into sliding contact with the guide part and turns the terminal in the direction W;

FIG. 6A is a sectional view of lances and a locking part, FIG. 6B is a sectional view of the stabilizer and the guide part, and FIG. 6C shows an example of a guide part having three stabilizers; and

FIG. 7 shows an example structure of a housing of a related art.

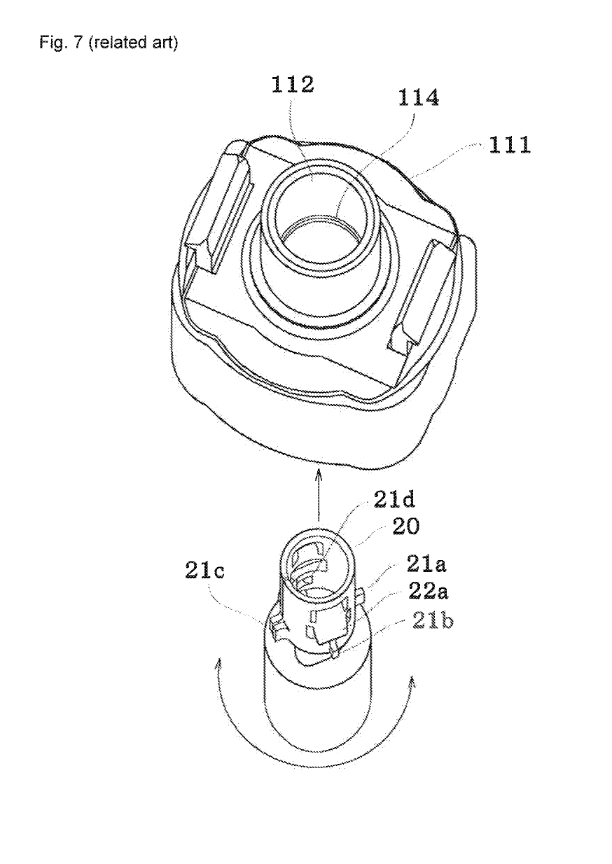

### DETAILED DESCRIPTION

A terminal locking structure for an electrical connector according to the present invention can be applied to various connectors, and an example in which the terminal locking structure is applied to waterproof connectors for connecting solar panels will be described below.

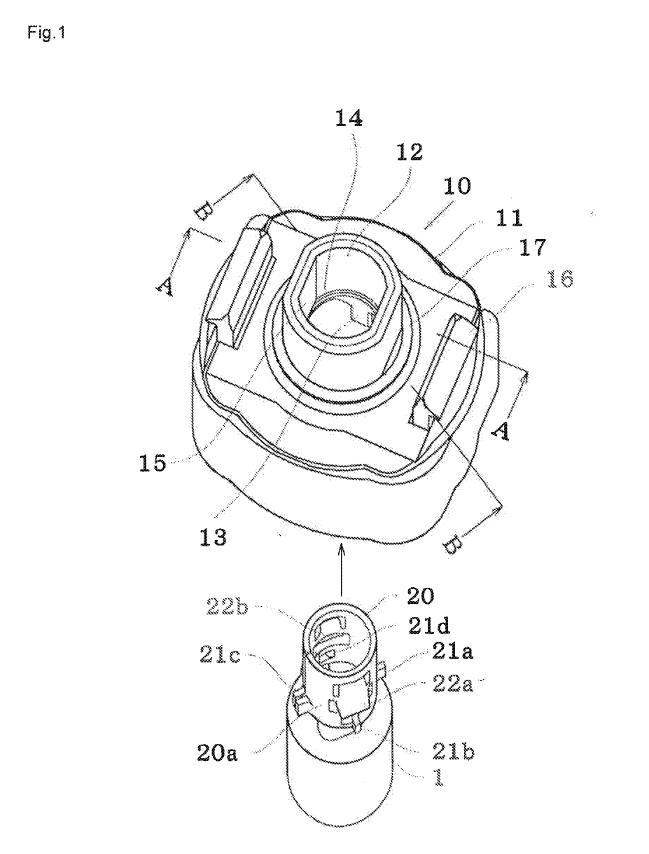

As shown in FIG. 1, a terminal 20 is inserted and attached into an insertion part 12 of a housing 11 made of resin of a connector 10 from the rear of the connector 10.

The insertion part 12 is provided with a guide part 13 and a lance locking part 14.

In this example, the housing 11 is provided with fitting pawls 16 on both sides thereof for fitting with a counterpart connector and a waterproof O-ring 17.

In this example, the terminal 20 is made of metal and provided with four stabilizers 21a to 21d formed by cutting and raising a cylindrical part 20a at equal interval along the outer circumference thereof and two lances 22a and 22b.

The terminal 20 is connected with a cable 1.

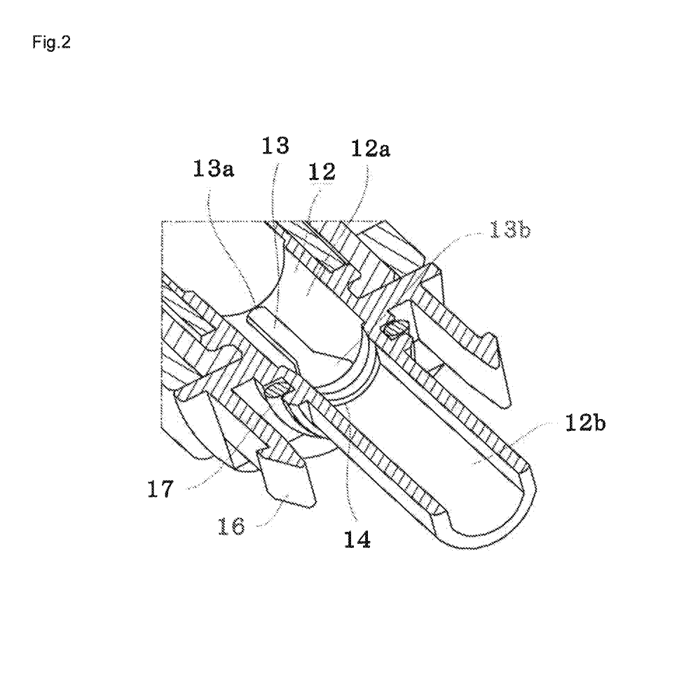

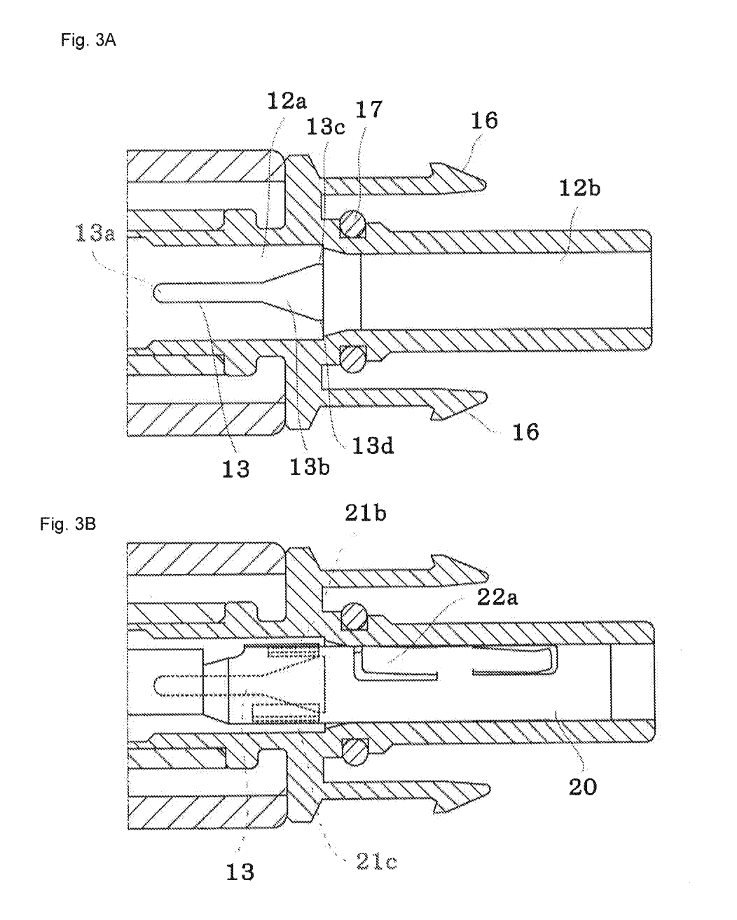

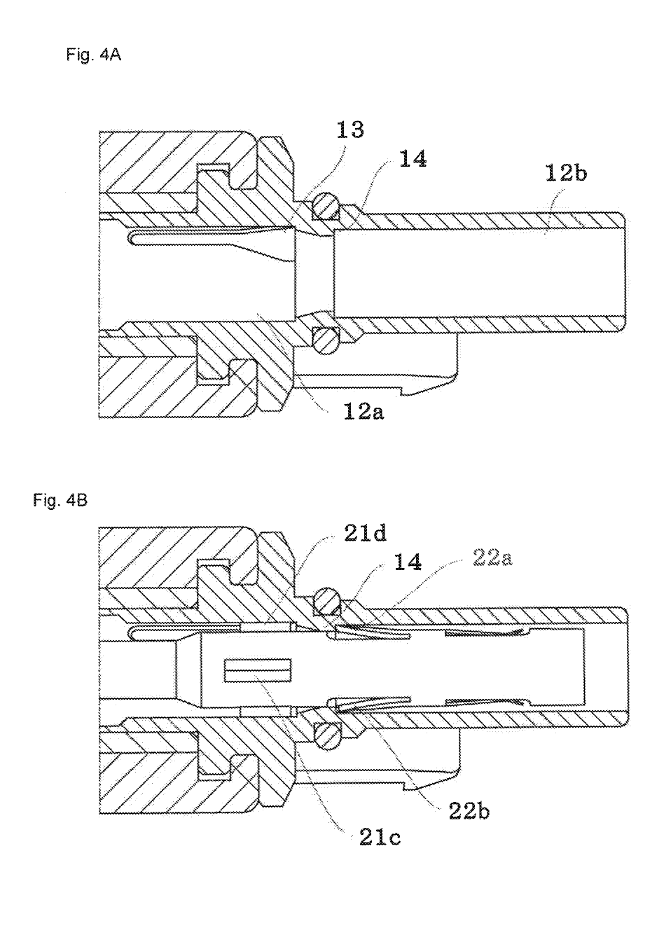

The present embodiment is an example of a waterproof socket connector as shown in FIGS. 2, 3A and 3B which are sectional views taken along line A-A in FIG. 1 and in FIGS. 4A and 4B which are sectional views taken along line B-B.

The insertion part 12 into which the terminal 20 is to be inserted and attached has a cylindrical terminal insertion part 12b in which a socket terminal part that can be fit and connected with a plug terminal of the counterpart connecter is placed and a stabilizer insertion part 12a at the rear of which the stabilizers 21a to 21d are to be positioned.

The terminal insertion part 12b also has, on the base side thereof, a stepped locking part 14 for locking the lances.

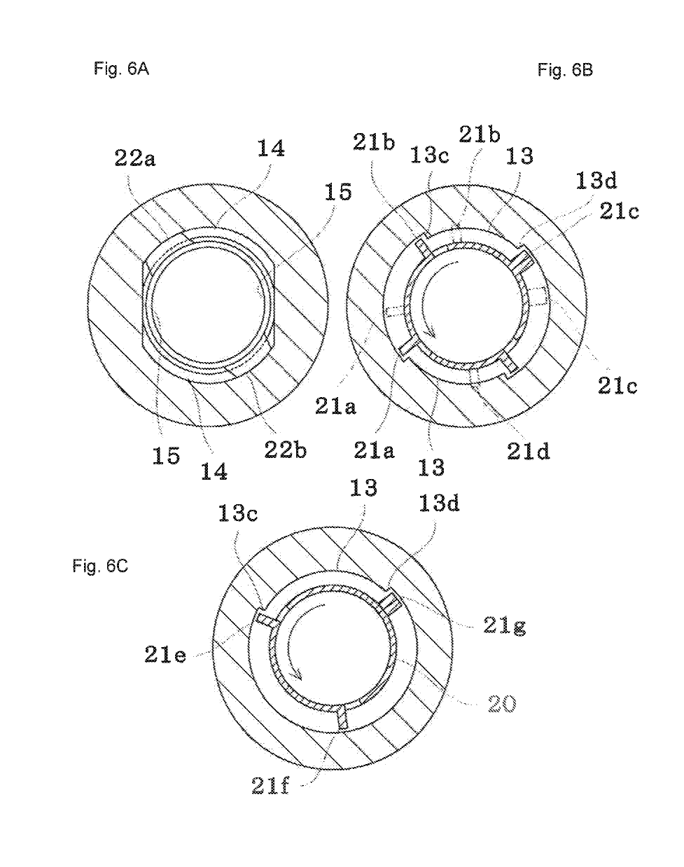

The locking part 14 is shown in a perspective view in FIG. 1, and as shown in the sectional view of FIG. 6A, the stepped locking part 14 capable of locking the lance 22a can be provided only partially and a region 15 where no locking part is formed is present owing to strength setting in this example.

The stabilizer insertion part 12a has a circular cross-section, and is provided, on the inner circumference thereof, with a guide part 13 protruding in a rib-like shape and having a tapered shape with a smaller width at a terminal insertion end 13a and a larger width at a terminal insertion rear portion 13b thereof as shown in FIGS. 1, 2, 3A and 3B.

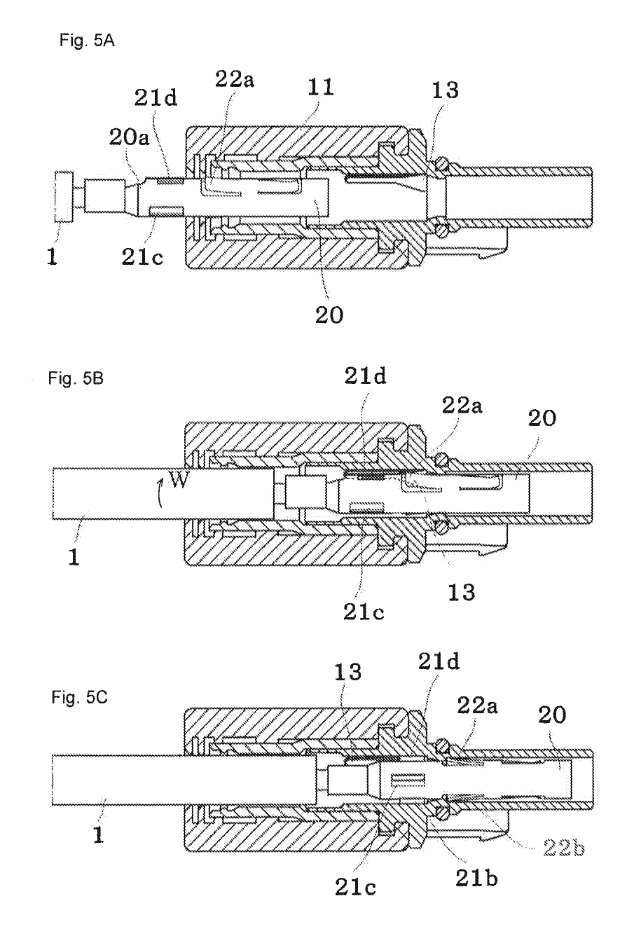

When the terminal 20 is inserted into the insertion part 12 from the rear of the housing 11 at a certain angle around the circumference as shown in FIG. 5A, the stabilizers 21a to 21d are inserted along sidewalls 13c and 13d of the guide part 13 as shown in FIG. 5B, which turns the cable and the terminal in the direction of an arrow W and locks the lances 22a and 22b by the locking part 14 provided at a predetermined position as shown in FIG. 5C.

FIG. 3B shows, by a dotted line, a state in which the stabilizers 21b and 21c are inserted along the side walls on both sides of the guide part 13.

The guide part 13 guides insertion of the stabilizers 21a to 21d to guide the locking position of the lances to a predetermined position, and at the same time, comes between adjacent stabilizers 21b and 21c on both sides thereof, which restricts free rotation of the terminal.

Such operation is shown in the sectional view of FIG. 6B.

While four stabilizers 21a to 21d are provided in the present embodiment, FIG. 6C shows an example of three stabilizers 21e to 21g.

### REFERENCE SIGN LIST

1 cable

10 connector

11 housing

12 insertion part

13 guide part

14 locking part

20 terminal

21a stabilizer

22a lance

What is claimed is:

1. A terminal locking structure for an electrical connector that locks a terminal into a housing of the electrical connector with a lance, wherein
the terminal includes the lance and a stabilizer on an outer circumference of a cylindrical part thereof,
the housing includes:
an insertion part into which the terminal is inserted;
a lance locking part provided only at a predetermined position along an inner circumference of the insertion part; and
a guide part for the stabilizer, the guide part being inserted along the insertion part, and
when the terminal is inserted into the insertion part of the housing, the stabilizer turns along the circumference along the guide part, which rotates the terminal to guide the lance to the lance locking part provided at the predetermined position of the housing.

2. The terminal locking structure for an electrical connector according to claim 1, wherein
three or more stabilizers are provided along the circumference of the cylindrical part,
the guide part has a tapered shape that becomes wider from a terminal insertion end toward a terminal insertion rear portion thereof,
the terminal is rotated while being inserted so that the guide part is positioned between two adjacent stabilizers of the stabilizers and the lance is guided to the predetermined position.
